(19) United States
(12) Patent Application Publication
(10) Pub. No.: US 2013/0129978 A1
(43) Pub. Date: May 23, 2013

(54) Articles and Methods Providing Supermetalophobic/philic Surfaces and Superceramophobic/philic Surfaces

(71) Applicant: Massachusetts Institute of Technology, Cambridge, MA (US)

(72) Inventors: Kripa K. Varanasi, Lexington, MA (US); Rajeev Dhiman, Malden, MA (US)

(73) Assignee: Massachusetts Institute of Technology, Cambridge, MA (US)

(21) Appl. No.: 13/683,186

(22) Filed: Nov. 21, 2012

Related U.S. Application Data
(60) Provisional application No. 61/562,729, filed on Nov. 22, 2011.

(51) Int. Cl. B05D 3/00; F01D 5/28

(52) U.S. Cl. CPC B05D 3/002; F01D 5/288
USPC 428/141; 427/444; 427/455; 427/299; 428/156; 416/241 R

(57) ABSTRACT

This invention relates generally to articles, devices, and methods for controlling the impingement behavior of molten metal/ceramic droplets on surfaces in industrial processes. The texture of a substrate surface is engineered such that impinging molten metal droplets actually bounce off the surface. Likewise, the texture of a substrate surface can be engineered such that impinging molten metal droplets stick to the surface.

### CROSS-REFERENCE TO RELATED APPLICATION

This application claims priority to and the benefit of, and incorporates herein by reference in its entirety, U.S. Provisional Patent Application No. 61/562,729, filed Nov. 22, 2011.

### FIELD OF THE INVENTION

This invention relates generally to articles and methods for controlling the impingement behavior of molten metal/ceramic droplets on surfaces in industrial processes.

### BACKGROUND OF THE INVENTION

Impingement of molten metal/ceramic droplets is encountered in a wide variety of industrial applications, for example, thermal spray process where coatings of metal or ceramics are deposited by spraying them in molten form at high velocities onto a substrate. Such coatings are used extensively for withstanding corrosion, erosion and thermal shock in many industries such as aerospace, automotive, ship building, and power. Another application is spray forming where raw materials at mass scale are produced by spraying molten metals and through control of the substrate motion, a variety of different shapes such as billets, strips, etc. can be produced. In each of these cases, individual droplets are the building blocks of the deposit and it is desired to maximize the deposition. For example, rather than having droplets fragment away from the surface, the goal is to make them stick.

On the other hand, there are other applications where the opposite effect is desired. For example, metal fouling in power plants where blades of a gas turbine are often fouled by metal/ceramic particles that originate from eroded surfaces of process equipment, such as, heat exchangers and get carried away along with the working fluid. Upon reaching high temperature sections of the turbine, these particles melt and impinge upon turbine blades and get stuck, thereby degrading aerodynamic performance of these blades and hence reducing plant efficiency. If these droplets could be prevented from sticking, significant savings in cost and energy would result. This is complicated by the fact that these applications typically involve oxidizing environments as well as by the fact that metals typically have much higher surface tensions than ordinary liquids.

Therefore, there is a need for articles and methods for controlling the impingement behavior of molten metal/ceramic droplets on surfaces in industrial processes.

### SUMMARY OF THE INVENTION

This invention relates generally to articles, devices, and methods for controlling the impingement behavior of molten metal/ceramic droplets on surfaces in industrial processes. It is discovered that the texture of a substrate surface can be engineered such that impinging molten metal droplets actually bounce off the surface. Likewise, it is discovered that the texture of a substrate surface can be engineered such that impinging molten metal droplets stick to the surface.

In one aspect, the invention features a method for preparing a surface to promote rebound of liquid metal droplets or ceramic droplets impinging thereupon, the method comprising the step of forming a micro-scale and/or nano-scale surface texture upon the surface prior to exposing the surface to an environment comprising liquid metal droplets or ceramic droplets. In some embodiments, the surface is an anti-fouling surface of a turbine blade.

In some embodiments, the surface texture is patterned (e.g., non-random). In some embodiments, the surface texture comprises features [e.g., solid features, discrete features, e.g., posts, pyramids, particles, layered particles, irregular shapes, pores, cavities (circular, square, hexagonal), stripes, and/or ridges] and has average feature spacing, b, such that 0.07<b/D<0.2, where D is the diameter of the liquid metal droplets or ceramic droplets. In some embodiments, the surface texture comprises features and has average feature spacing, b, such that 7 μm<b<200 μm [e.g., 35 μm<b<120 μm (e.g., where D=0.6 mm)]. In some embodiments, the surface texture comprises features and has average feature width [or corresponding characteristic dimension such as diameter or depth], a, such that 0.001<a/D<0.1, where D is the diameter of the liquid metal droplets or ceramic droplets. In some embodiments, the surface texture comprises features and has average feature width, a, such that 0.1 μm <a<100 μm [e.g., 0.6 μm<a<60 μm (e.g., where D=0.6 mm)]. In some embodiments, the surface texture comprises features and has average feature height, h, such that 0.01<h/D<0.1, where D is the diameter of the liquid metal droplets or ceramic droplets. In some embodiments, the surface texture comprises features and has average feature height, h, such that 1 μm<h<100 μm [e.g., 6 μm<h<60 μm (e.g., where D=0.6 mm)].

In some embodiments, cos θ<(1−φ))/(r−φ), where θ is contact angle of the liquid metal droplet or ceramic droplet on the surface without surface texture thereupon (e.g., smooth surface), r is ratio of total surface area to projected area of solid surface, and φ is fraction of the projected area of the surface occupied by solid.

In another aspect, the invention features a method for preparing a surface to promote sticking of molten metal droplets or ceramic droplets impinging thereupon, the method comprising the step of forming a micro-scale and/or nano-scale surface texture upon the surface prior to exposing the surface to an environment comprising liquid metal droplets or ceramic droplets. In some embodiments, the method comprises the step of coating the surface with a metal (e.g., an alloy) or ceramic in a thermal spray process. In some embodiments, the method comprises the step of spraying a molten metal onto the surface in a spray forming process (e.g., gas atomized spray forming, GASF).

In some embodiments, the surface texture is patterned (e.g., non-random). In some embodiments, the surface texture comprises features [e.g., solid features, discrete features, posts, pyramids, particles, layered particles, irregular shapes, pores, cavities (circular, square, hexagonal), stripes, and/or ridges] and has average feature spacing, b, such that 0.01<b/D<1, where D is the diameter of the liquid metal droplets or ceramic droplets. In some embodiments, the surface texture comprises features and has average feature spacing, b, such that 0.1 μm<b<100 μm [e.g., 0.6 μm<b<60 μm (e.g., where D=0.06 mm)]. In some embodiments, the surface texture comprises features and has average feature width [or corresponding characteristic dimension such as diameter or depth], a, such that 0.001<a/D<0.1, where D is the diameter of the liquid metal droplets or ceramic droplets. In some embodiments, the surface texture comprises features and has average feature width, a, such that 0.01 μm<a<10 μm [e.g., 0.06μm<a<6 μm (e.g., where D=0.06 mm)]. In some embodiments, the surface texture comprises features and has average feature height, h, such that 0.001<h/D<0.1, where D is the diameter of the liquid metal droplets or ceramic droplets. In some embodiments, the surface texture comprises features and has average feature height, h, such that 0.01 μm<h<10 μm [e.g., 0.06 μm<h<6 μm (e.g., where D=0.06 mm)].

In some embodiments, cos θ>(1−φ)/(r−φ), where θ is contact angle of the liquid metal droplet or ceramic droplet on the surface without surface texture thereupon (e.g., smooth surface), r is ratio of total surface area to projected area of solid surface, and φ is fraction of the projected area of the surface occupied by solid.

In another aspect, the invention features an article comprising a surface configured to promote rebound of liquid metal droplets or ceramic droplets impinging thereupon, the article comprising a surface having a micro-scale and/or nano-scale surface texture. In some embodiments, the article is a turbine blade and the surface is an anti-fouling surface of the turbine blade. In some embodiments, the surface texture is patterned (e.g., non-random). In some embodiments, the surface texture comprises features [e.g., solid features, discrete features, posts, pyramids, particles, layered particles, irregular shapes, pores, cavities (circular, square, hexagonal), stripes, and/or ridges] and has average feature spacing, b, such that 0.07<b/D<0.2, where D is the diameter of the liquid metal droplets or ceramic droplets. In some embodiments, the surface texture comprises features and has average feature spacing, b, such that 7 μm<b<200 μm [e.g., 35 μm<b<120 μm (e.g., where D=0.6 mm)]. In some embodiments, the surface texture comprises features and has average feature width [or corresponding characteristic dimension such as diameter or depth], a, such that 0.001<a/D<0.1, where D is the diameter of the liquid metal droplets or ceramic droplets. In some embodiments, the surface texture comprises features and has average feature width, a, such that 0.1 μm<a<100 μm [e.g., 0.6 μm<a<60 μm (e.g., where D=0.6 mm)]. In some embodiments, the surface texture comprises features and has average feature height, h, such that 0.01<h/D<0.1, where D is the diameter of the liquid metal droplets or ceramic droplets. In some embodiments, the surface texture comprises features and has average feature height, h, such that 1 μm<h<100 μm [e.g., 6 μm<h<60 μm (e.g., where D=0.6 mm)].

In some embodiments, cos θ<(1−φ)/(r−φ), where θ is contact angle of the liquid metal droplet or ceramic droplet on the surface without surface texture thereupon (e.g., smooth surface), r is ratio of total surface area to projected area of solid surface, and φ is fraction of the projected area of the surface occupied by solid.

In another aspect, the invention features an article comprising a surface configured to promote sticking of molten metal droplets or ceramic droplets impinging thereupon, the article having a surface having a micro-scale and/or nano-scale surface texture. In some embodiments, the surface texture is patterned (e.g., non-random). In some embodiments, the surface texture comprises features [e.g., solid features, discrete features, posts, pyramids, particles, layered particles, irregular shapes, pores, cavities (circular, square, hexagonal), stripes, and/or ridges] and has average feature spacing, b, such that 0.01<b/D<1, where D is the diameter of the liquid metal droplets or ceramic droplets. In some embodiments, the surface texture comprises features and has average feature spacing, b, such that 0.1 μm<b<100 μm [e.g., 0.6 μm<b<60 μm (e.g., where D=0.06 mm)]. In some embodiments, the surface texture comprises features and has average feature width [or corresponding characteristic dimension such as diameter or depth], a, such that 0.001<a/D<0.1, where D is the diameter of the liquid metal droplets or ceramic droplets. In some embodiments, the surface texture comprises features and has average feature width, a, such that 0.01 μm<a<10 μm [e.g., 0.06 μm<a<6 μm (e.g., where D=0.06 mm)]. In some embodiments, the surface texture comprises features and has average feature height, h, such that 0.001<h/D<0.1, where D is the diameter of the liquid metal droplets or ceramic droplets. In some embodiments, the surface texture comprises features and has average feature height, h, such that 0.01 μm<h<10 μm [e.g., 0.06 μm<h<6 μm (e.g., where D=0.06 mm)].

In some embodiments, cos θ>(1−φ)/(r−φ), where θ is contact angle of the liquid metal droplet or ceramic droplet on the surface without surface texture thereupon (e.g., smooth surface), r is ratio of total surface area to projected area of solid surface, and φ is fraction of the projected area of the surface occupied by solid.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

While the invention is particularly shown and described herein with reference to specific examples and specific embodiments, it should be understood by those skilled in the art that various changes in form and detail may be made therein without departing from the spirit and scope of the invention.

FIG. 1a is a schematic side view of a droplet resting on a surface during a static contact angle measurement, according to an illustrative embodiment of the invention.

FIGS. 1b and 1c are schematic side views of a liquid spreading and receding, respectively, on a surface, according to an illustrative embodiment of the invention.

FIG. 1d is a schematic side view of a droplet resting on an angled surface, according to an illustrative embodiment of the invention.

FIG. 2 depicts side views of molten tin droplets impinging a silicon micropost surface, according to an illustrative embodiment of the invention.

FIG. 3 depicts side views of molten tin droplets impinging a silicon micropost surface when the surface temperature was below the melting point of the droplet, according to an illustrative embodiment of the invention.

FIG. 4 depicts side views of molten tin droplets impinging a silicon nanograss surface when the surface temperature was reduced, according to an illustrative embodiment of the invention

### DETAILED DESCRIPTION

It is contemplated that compositions, mixtures, systems, devices, methods, and processes of the claimed invention encompass variations and adaptations developed using information from the embodiments described herein. Adaptation and/or modification of the compositions, mixtures, systems, devices, methods, and processes described herein may be performed by those of ordinary skill in the relevant art.

Throughout the description, where articles, devices and systems are described as having, including, or comprising specific components, or where processes and methods are described as having, including, or comprising specific steps, it is contemplated that, additionally, there are articles, devices, and systems of the present invention that consist essentially of, or consist of, the recited components, and that there are processes and methods according to the present invention that consist essentially of, or consist of, the recited processing steps.

Similarly, where articles, devices, mixtures, and compositions are described as having, including, or comprising specific compounds and/or materials, it is contemplated that, additionally, there are articles, devices, mixtures, and compositions of the present invention that consist essentially of, or consist of, the recited compounds and/or materials.

It should be understood that the order of steps or order for performing certain actions is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

The use of non-wetting surfaces for reducing the contact time between an impinging liquid and the surface is described in U.S. patent application Ser. No. 13/300,022, entitled, “Methods for Reducing Contact Time of Drops on Superhydrophobic Surfaces,” the text of which is hereby incorporated by reference herein in its entirety.

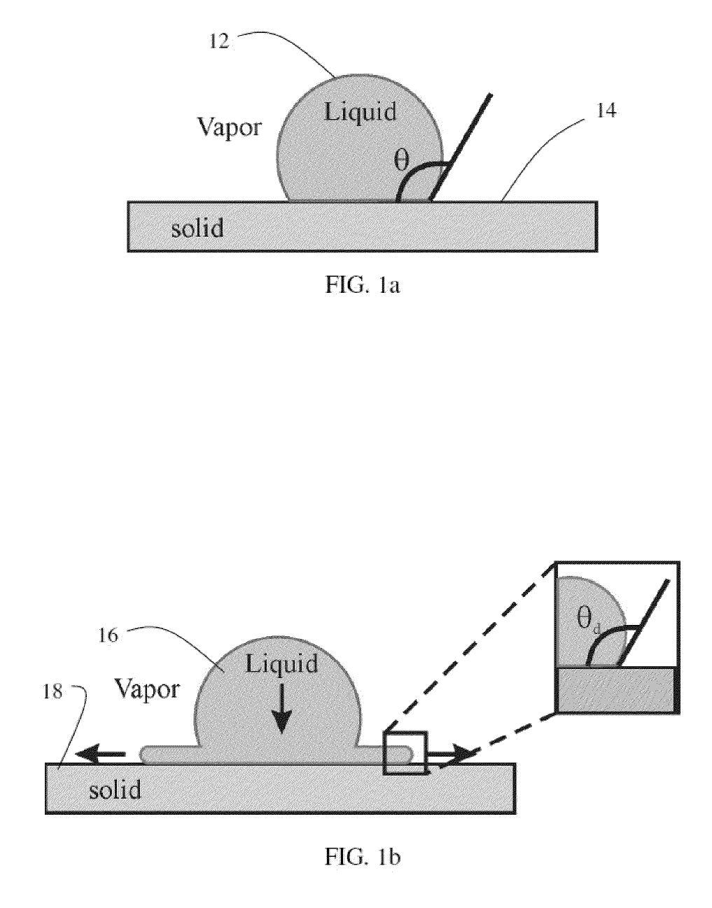

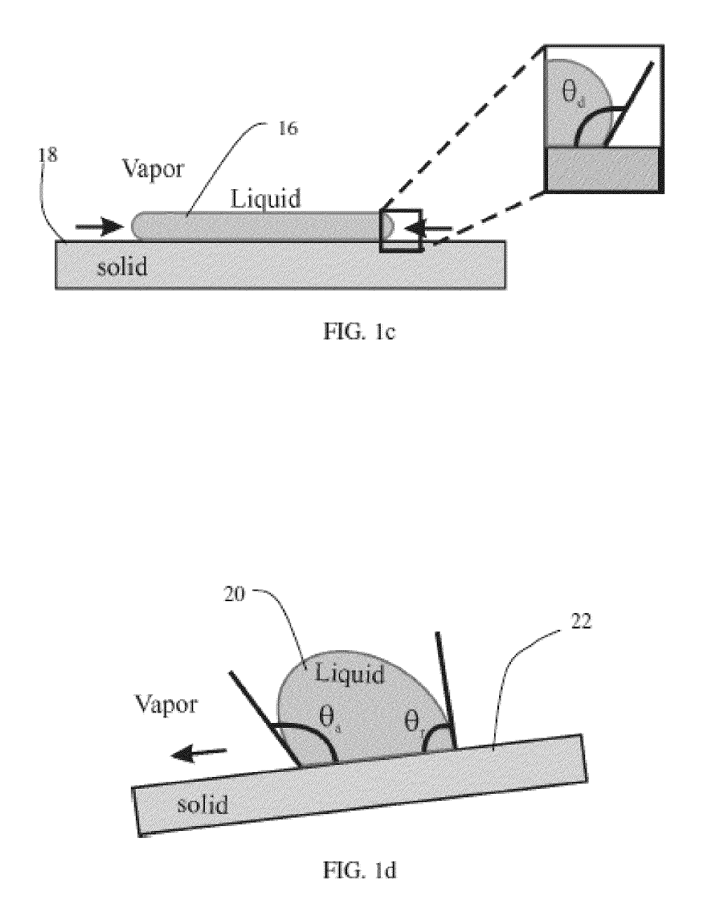

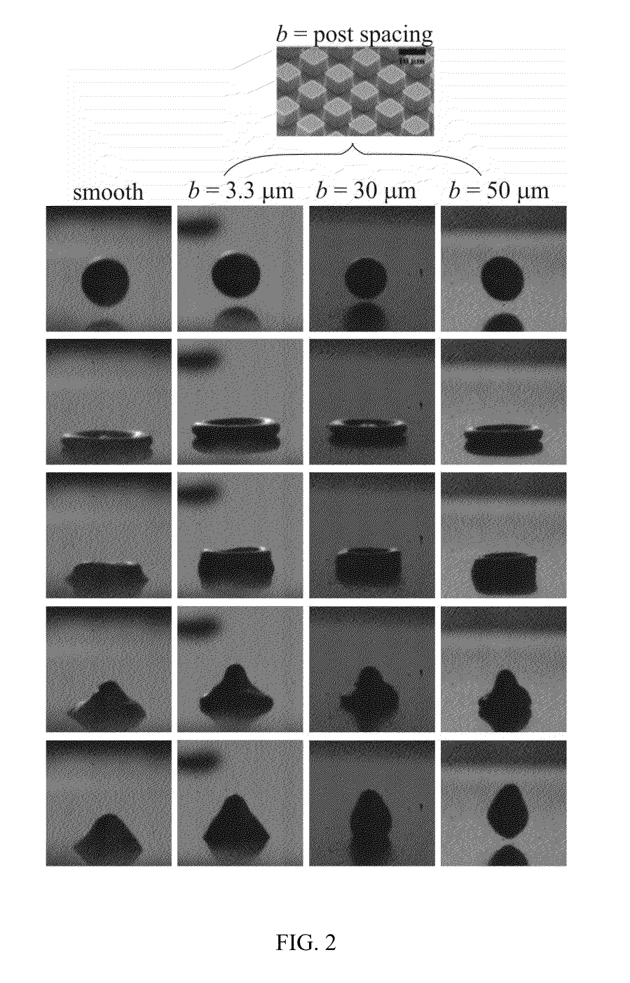

Referring to FIG. 1a, in certain embodiments, a static contact angle θ between a liquid and solid is defined as the angle formed by a liquid drop 12 on a solid surface 14 as measured between a tangent at the contact line, where the three phases—solid, liquid, and vapor—meet, and the horizontal. The term “contact angle” usually implies the static contact angle θ since the liquid is merely resting on the solid without any movement.

As used herein, dynamic contact angle, θ_{d}, is a contact angle made by a moving liquid 16 on a solid surface 18. In the context of droplet impingement, θ_{d} may exist during either advancing or receding movement, as shown in FIGS. 1b and 1c, respectively.

As used herein, contact angle hysteresis (CAH) is

CAH=θₐθ−ᵣ (2)

where θₐ and θᵣ are advancing and receding contact angles, respectively, formed by a liquid 20 on a solid surface 22. Referring to FIG. 1d, the advancing contact angle θₐ is the contact angle formed at the instant when a contact line is about to advance, whereas the receding contact angle θᵣ is the contact angle formed when a contact line is about to recede.

As used herein, “non-wetting features” are physical textures (e.g., random, including fractal, or patterned surface roughness) on a surface that, together with the surface chemistry, make the surface non-wetting. In certain embodiments, non-wetting features result from chemical, electrical, and/or mechanical treatment of a surface. In certain embodiments, an intrinsically metallophobic surface may become supermetallophobic when non-wetting features are introduced to the intrinsically metallophobic surface.

As used herein, a “supermetallophobic” surface is a surface having a static contact angle with a liquid metal of at least 120 degrees and a CAH with liquid metal of less than 30 degrees. Similarly, as used herein, a “superceramophobic” surface is a surface having a static contact angle with a liquid metal of at least 120 degrees and a CAH with liquid ceramic of less than 30 degrees. In certain embodiments, an intrinsically metallophobic material (i.e., a material having an intrinsic contact angle with liquid metal of at least 90 degrees) exhibits supermetallophobic properties when it includes non-wetting features. Similarly, an intrinsically ceramophobic material (i.e., a material having an intrinsic contact angle with liquid ceramic of at least 90 degrees) exhibits superceramophobic properties when it includes non-wetting features. Examples of intrinsically metallophobic and/or ceramophobic materials that exhibit supermetallophobic properties and/or superceramophobic properties when given non-wetting features include: teflon, trichloro(1H,1H,2H,2H-perfluorooctyl)silane (TCS), octadecyltrichlorosilane (OTS), heptadecafluoro-1,1,2,2-tetrahydrodecyltrichlorosilane, fluoroPOSS, and other fluoropolymers. Further examples of metallophobic materials include molten tin on stainless steel, silica, and molten copper on niobium.

In certain embodiments, non-wetting features are micro-scale or nano-scale features. For example, the non-wetting features may have a length scale Lₙ (e.g., an average pore diameter, or an average protrusion height) that is less than about 100 microns, less than about 10 microns, less than about 1 micron, less than about 0.1 microns, or less than about 0.01 microns. Compared to a length scale Lₘ associated with macro-scale features, described herein, the length scales for the non-wetting features are typically at least an order of magnitude smaller. For example, when a surface includes a macro-scale feature that has a length scale Lₘ of 1 micron, the non-wetting features on the surface have a length scale L that is less than 0.1 microns. In certain embodiments a ratio of the length scale for the macro-scale features to the length scale for the non- wetting features (i.e., Lₘ/Lₙ) is greater than about 10, greater than about 100, greater than about 1000, or greater than about 10,000.

The non-wetting features may be non-random. In certain embodiments, the features are patterned. Alternatively or in addition to microposts and nanograss shown in FIGS. 2 and 4, other exemplary features of practical interest include, but are not limited to, pyramid, layered particles, holes (e.g., circular, square, or hexagonal), and stripes. Features could be with or without hierarchical features: for example, microparticles with nanowires, or micropyramids with nanoparticles.

Described herein are experiments with surfaces/coatings with controlled impingement behavior of molten metal/ceramic droplets, for which a systematic demonstration of development towards complete rebound or deposition on target surfaces is performed. These surfaces/coatings can improve efficiency and reduce costs in a wide variety of industrial applications such as power plant metal fouling, thermal spray coating, spray forming, solder jet bumping, and rapid prototyping

It is believed that according to a thermodynamic criterion of liquid deposition on a textured solid surface, deposition is possible if:

$$cos θ \text{?} \text{?} \text{indicates text missing or illegible when filed} \qquad ( 1 )$$

In the above equation, is the contact angle of the liquid on the smooth solid whose surface is textured with a microscopic roughness characterized by the parameters r and φ, defined as the ratio of total surface area to the projected area of the solid and the fraction of the projected area of the surface that is occupied by the solid, respectively. For example, in the case of square microposts with width a, edge-to-edge spacing b, and height h (FIG. 2), φ=a²1(a+b)² and r=1+4ah/(a+b)². Hence, surface texture can be tailored to control liquid deposition and appropriately designed texture can even result in complete rebound of an impinging liquid.

By appropriately designing surface textures and controlling φ, both metalophilicity (deposition) and metalophobicity (bouncing) can be achieved. The desired size range for surface textures is determined by the target application along with Eq. (1) and is set relative to the droplet diameter and impact velocity.

In certain embodiments, Table 1 is used to identify appropriate dimensions for the features described herein, depending on the respective applications.

TABLE 1
Dimensions of micropost-patterned surfaces in different applications

| | Droplet | Impact | |
|---|---|---|---|
| | diameter, | Velocity, V | |
| Application | D (mm) | (m/s) | Texture Dimensions |
| metal fouling of turbines (metalo- phobic surface is desired) | 0.1-1 | 10-100 | $0.001 < \frac{a}{D} < 0.1$ $0.07 < \frac{b}{D} < 0.2$ $0.01 < \frac{h}{D} < 0.1$ |
| thermal spray coatings (metalo- philic surface is desired) | 0.01-0.1 | 50-200 | $0.001 < \frac{a}{D} < 0.1$ $0.01 < \frac{b}{D} < 1$ $0.001 < \frac{h}{D} < 0.1$ |

Referring to FIG. 2, it shows SEM of the silicon micropost surface (the scale bar is 10 μm) and high-speed photography images of molten tin droplets (diameter 0.6 mm) impinging on silicon surfaces. While on the smooth surface, the droplet gets stuck, by texturing the substrate surface, the droplet is able to bounce-off at b=50 μm. The substrate temperature and the droplet impact velocity were 240° C. and 1.7 m/s in all cases

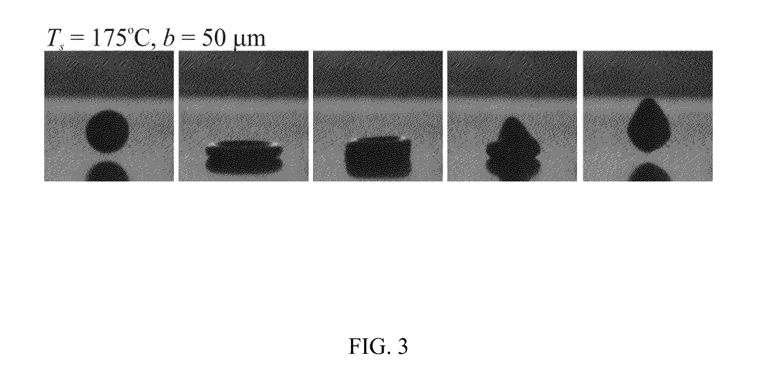

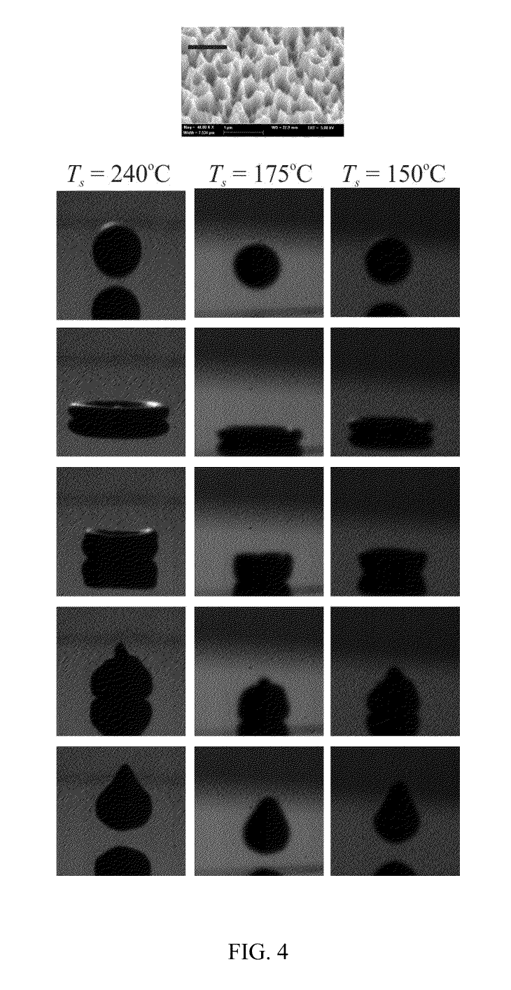

Furthermore, FIG. 3 shows high-speed photography images of a molten tin droplet (diameter 0.6 mm) impinging on a silicon surface with cubical microposts. The droplet bounces off even when the surface temperature was below the melting point of the droplet (232° C.).

Similarly, FIG. 4 includes SEM of the nanograss silicon surface (scale bar is 1 μm) and high-speed photography images of a molten tin droplet (diameter 0.6 mm) bouncing-off the surface even when the surface temperature was reduced to 150° C.

In some embodiments, the invention relates to an article for use in industrial operation or research.

### Experiments

Experiments were conducted to observe molten metal droplets impinging onto substrates whose surface texture features were precisely controlled. Droplets of molten tin (melting point 232° C., density=6970 Kg M⁻³, surface tension=0.526 Nm⁻¹, viscosity=1.917×10⁻³ Pa-s) were produced with the help of droplet-on-demand droplet generator. Droplet size, velocity, and temperature were 0.6 mm, 1.7 m/s, and 240° C., respectively. The temperature of the substrate was controlled by using cartridge heaters inserted in a copper block onto which the substrate was mounted. Substrate temperature was varied between 25-240° C. to determine its effect of on the outcome of the droplet impingement process. As mentioned previously, a key parameter was substrate surface texture which was precisely controlled: we used three different surface textures on silicon—square microposts (a=h=10 μm, FIG. 2), nanograss (average height ˜100 nm, FIG. 3), and mirror polished silicon as a baseline case. For the case of liquid tin on silicon surface, φ=140°(and cos θ=−0.77) suggesting that droplet bouncing can be achieved by adding texture provided additional forces such as pinning and solidification, which prevent bouncing, are also overcome. FIG. 2 shows the impingement of a molten tin droplet on silicon surfaces with different texture dimensions, including the smooth case. The surface was kept above the melting point of tin (232° C.) so that there was no solidification of the tin droplet during the impingement process. The images show that the droplet remains stuck to the surface until the texture is diluted enough (by increasing b) when we were able to achieve complete rebound of the droplet (see FIG. 2). This surface (b=50 μm) therefore exhibits supermetalophobic properties. Another advantage of diluting surface texture (for example, by increasing b) is that the heat transfer from the spreading droplet to the surface is also reduced, thereby delaying droplet solidification, which is known to arrest the droplet on the surface. Thus, at b=50 μm, we were able to prevent droplet stickiness even when the temperature of the surface was reduced to 175° C.—about 60° C. below the melting point of the droplet, see FIG. 3. Even further reduction in this subcooling degree (the temperature decrease until droplet sticks) can be achieved by using a nano-scale texture shown in FIG. 4. In this case, the droplet rebounded even when the surface temperature was reduced to 150° C.—a subcooling of over 80° C. (see FIG. 4).

### Equivalents

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A method for preparing a surface to promote rebound of liquid metal droplets or ceramic droplets impinging thereupon, the method comprising the step of forming a micro-scale and/or nano-scale surface texture upon the surface prior to exposing the surface to an environment comprising liquid metal droplets or ceramic droplets.

2. The method of claim 1, wherein the surface is an anti-fouling surface of a turbine blade.

3. The method of claim 1, wherein the surface texture is patterned.

4. The method of claim 1, wherein the surface texture comprises features and has average feature spacing, b, such that 0.07<b/D<0.2, where D is the diameter of the liquid metal droplets or ceramic droplets.

5. The method of claim 1, wherein the surface texture comprises features and has average feature spacing, b, such that 7 μm<b<200 μm.

6. The method of claim 1, wherein the surface texture comprises features and has average feature width, a, such that 0.001<a/D<0.1, where D is the diameter of the liquid metal droplets or ceramic droplets.

7. The method of claim 1, wherein the surface texture comprises features and has average feature width, a, such that 0.1 μm<a<100 μm.

8. The method of claim 1, wherein the surface texture comprises features and has average feature height, h, such that 0.01<h/D<0.1, where D is the diameter of the liquid metal droplets or ceramic droplets.

9. The method of claim 1, wherein the surface texture comprises features and has average feature height, h, such that 1 μm <h<100 μm.

10. The method of claim 1, wherein cos θ<(1−φ)/(r−φ), where θ is contact angle of the liquid metal droplet or ceramic droplet on the surface without surface texture thereupon, r is ratio of total surface area to projected area of solid surface, and φ is fraction of the projected area of the surface occupied by solid.

11. A method for preparing a surface to promote sticking of molten metal droplets or ceramic droplets impinging thereupon, the method comprising the step of forming a micro-scale and/or nano-scale surface texture upon the surface prior to exposing the surface to an environment comprising liquid metal droplets or ceramic droplets.

12. The method of claim 11, further comprising the step of coating the surface with a metal (e.g., an alloy) or ceramic in a thermal spray process.

13. The method of claim 11, further comprising the step of spraying a molten metal onto the surface in a spray forming process (e.g., gas atomized spray forming, GASF).

14. The method of claim 11, wherein the surface texture is patterned.

15. The method of claim 11, wherein the surface texture comprises features and has average feature spacing, b, such that 0.01<b/D<1, where D is the diameter of the liquid metal droplets or ceramic droplets.

16. The method of claim 11, wherein the surface texture comprises features and has average feature spacing, b, such that 0.1 μm<b<100 μm.

17. The method of claim 11, wherein the surface texture comprises features and has average feature width, a, such that 0.001<a/D<0.1, where D is the diameter of the liquid metal droplets or ceramic droplets.

18. The method of claim 11, wherein the surface texture comprises features and has average feature width, a, such that 0.01μm<a<10 μm.

19. The method of claim 11, wherein the surface texture comprises features and has average feature height, h, such that 0.001<h/D<0.1, where D is the diameter of the liquid metal droplets or ceramic droplets.

20. The method of claim 11, wherein the surface texture comprises features and has average feature height, h, such that 0.01 μm<h<10 μm.

21. The method of claim 11, wherein cos θ>(1−φ)/(r−φ), where θ is contact angle of the liquid metal droplet or ceramic droplet on the surface without surface texture thereupon, r is ratio of total surface area to projected area of solid surface, and φ is fraction of the projected area of the surface occupied by solid.

22. An article comprising a surface configured to promote rebound of liquid metal droplets or ceramic droplets impinging thereupon, the article comprising a surface having a micro-scale and/or nano-scale surface texture.

23. The article of claim 22, wherein the article is a turbine blade and the surface is an anti-fouling surface of the turbine blade.

24. The article of claim 22, wherein the surface texture is patterned.

25. The article of claim 22, wherein the surface texture comprises features and has average feature spacing, b, such that 0.07<b/D<0.2, where D is the diameter of the liquid metal droplets or ceramic droplets.

26. The article of claim 22, wherein the surface texture comprises features and has average feature spacing, b, such that 7 μm<b<200 μm.

27. The article of claim 22, wherein the surface texture comprises features and has average feature width, a, such that 0.001<a/D<0.1, where D is the diameter of the liquid metal droplets or ceramic droplets.

28. The article of claim 22, wherein the surface texture comprises features and has average feature width, a, such that 0.1 μm<a<100 μm.

29. The article of claim 22, wherein the surface texture comprises features and has average feature height, h, such that 0.01<h/D<0.1, where D is the diameter of the liquid metal droplets or ceramic droplets.

30. The article of claim 22, wherein the surface texture comprises features and has average feature height, h, such that 1 μm<h<100 μm.

31. The article of claim 22, wherein cos θ<(1−φ)/(r−φ), where θ is contact angle of the liquid metal droplet or ceramic droplet on the surface without surface texture thereupon, r is ratio of total surface area to projected area of solid surface, and φ is fraction of the projected area of the surface occupied by solid.

32. An article comprising a surface configured to promote sticking of molten metal droplets or ceramic droplets impinging thereupon, the article having a surface having a micro-scale and/or nano-scale surface texture.

33. The article of claim 32, wherein the surface texture is patterned (e.g., non-random).

34. The article of claim 32, wherein the surface texture comprises features and has average feature spacing, b, such that 0.01<b/D<1, where D is the diameter of the liquid metal droplets or ceramic droplets.

35. The article of claim 32, wherein the surface texture comprises features and has average feature spacing, b, such that 0.1 μm<b<100 μm.

36. The article of claim 32, wherein the surface texture comprises features and has average feature width, a, such that 0.001<a/D<0.1, where D is the diameter of the liquid metal droplets or ceramic droplets.

37. The article of claim 32, wherein the surface texture comprises features and has average feature width, a, such that 0.01 μm<a<10 μm.

38. The article of claim 32, wherein the surface texture comprises features and has average feature height, h, such that 0.001<h/D<0.1, where D is the diameter of the liquid metal droplets or ceramic droplets.

39. The article of claim 32, wherein the surface texture comprises features and has average feature height, h, such that 0.01 μm<h<10 μm.

40. The article of claim 32, wherein cos θ>(1−φ)/(r−φ), where θ is contact angle of the liquid metal droplet or ceramic droplet on the surface without surface texture thereupon, r is ratio of total surface area to projected area of solid surface, and φ is fraction of the projected area of the surface occupied by solid.
